(19) United States
(12) Patent Application Publication
(10) Pub. No.: US 2004/0143693 A1
(43) Pub. Date: Jul. 22, 2004

(54) Data storage apparatus of multiple serial interfaces

(76) Inventor: Denny Hwang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/347,197

(22) Filed: Jan. 21, 2003

(51) Int. Cl. G06F 13/14

(52) U.S. Cl. 710/305

(57) ABSTRACT

The present invention provides a data storage apparatus with a multiple serials interface. The data storage apparatus is including a memory providing for data storing; a microprocessor used for controlling the access of a data stored in the memory; two serial bus interfaces connecting to the microprocessor or built-in in the microprocessor, wherein those two serial bus interfaces are including a universal serial bus (USB) interface and at least a non-USB interface for dealing with a communication protocol and a transmission of the connecting interface; a connecting port, wherein the connecting port is USB compatible and is electrically connecting with the serial bus interfaces for providing the connection to a digital apparatus to form an interface connection relation thereof; and an interface switch controller used for detecting an interface property connected by the connecting port and to converting to the corresponding serial bus interface. Hence, the present invention provides with advantages of the conveniently transmission, the low cost, and flexibly selecting the interface.

### BACKGROUND OF THE INVENTION

1. Field of the Invention

The present invention generally relates to a storage apparatus, and more particularly relates to a data storage apparatus with a multiple serials interface, which can be suitable for connecting with the digital apparatus with different connection interface.

2. Description of the Prior Art

With the development of the information industry, various kinds of the electronics products, such as the mobile phone, the notebook computer, the personal digital assistant (PDA), the multi media digital video/audio broadcaster, and the digital camera, provide different applications of video/audio multi media and data Internet transmission in the usual life. These portable electronics products usually need to store all kinds of the electronics data and to mutually transmit the information. Hence, the data storage apparatus and the interface play very important role thereof.

Currently, the University Serial Bus (USB) is the most common interface to extensively apply to all kinds of digital apparatuses. Comparing with the conventional serial port, which is provided with the disadvantages of low speed and not identifying the peripheral applied apparatus, the USB interface is provided with the characteristics of plug-and-play and high transmission speed. Therefore, the user does not need to restart the computer but can immediately through the support of the operation flat to set the peripheral equipments externally build.

The USB interface is very common used in the computer now. However, some digital equipment without the USB interface still could not connect with other serial interface and could not apply to the use of the USB memory apparatus. Besides, some prior serial ports have the problem that the signal lines are not enough. On the other hand, currently, a USB on-the-go transmission specification is developed so as the data transmission does not require the connection of the computer can directly form the interface connection. However, the USB with On-the-Go has the complex structure and the high cost so cause the problem of not easily commonly used.

Hence, the main spirit of the invention is to provide a data storage apparatus with a multiple serials interface so as the present invention can easily be used as a transmission media of the electronics data between the computer end with the USB connecting port and the digital apparatus with different connecting ports, and then some disadvantages of well-known technology are overcome.

### SUMMARY OF THE INVENTION

The primary object of the present invention is to provide a data storage apparatus with a multiple-serials interface, which can not only be suitable for the USB interface but also the non-USB interface. The present invention utilizes the same connecting port to connect the digital apparatus with different connection interface and provides the effect of the multi serial interface so as the data transmission becomes more convenient.

Another object of the present invention is to provide a portable data storage apparatus provided with a multiple serials interface, which simultaneously provides with the advantage of the simple structure design and the low cost.

A further object of the present invention is for the user to flexibly select the serial interface corresponding to the requirement of the system architecture.

A furthermore object of the present invention is to utilize a electronic power input port to provide the required electronic power of the data storage apparatus so as the electronic power signal line of the connecting port can be used as the data controlling line to achieve the effect of increasing the amount of the data controlling lines.

Another furthermore object of the present invention is to not consume the electronic power of the digital apparatus while the data storage apparatus is connecting with the digital apparatus.

In order to achieve previous objects, the present invention provides a data storage apparatus with a multiple-serials interface. The data storage apparatus is including a memory providing for data storing; a microprocessor used for controlling the access of data stored in the memory; two serial bus interfaces connecting to the microprocessor or built-in in the microprocessor, wherein those two serial bus interfaces are including a universal serial bus (USB) interface and at least a non-USB interface for dealing with a communication protocol and a transmission of the connecting interface; a connecting port, wherein the connecting port is USB compatible and is electrically coupled with the serial bus interfaces for providing the connection to a digital apparatus to form an interface connection relation thereof; and an interface switch controller used for detecting an interface property connected by the connecting port and to converting to the corresponding serial bus interface.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the block diagram of the architecture, in accordance with one preferred embodiment of the present invention;

FIG. 2 is a schematic representation of the block diagram of the architecture, in accordance with another preferred embodiment of the present invention;

FIG. 3 is a schematic representation of one applied circuit, in accordance with the present invention;

FIG. 4 is a schematic representation of converting connecting interface, in accordance the FIG. 3 of the present invention; and

FIG. 5 is a schematic representation of another applied circuit, in accordance with the present invention.

### DESCRIPTION OF THE PREFERRED EMBODIMENT

The present invention utilizes a data storage apparatus provided with various kinds of serial interfaces, which is not only provided with the USB interface, but also provided with other serial interfaces, so as the data storage apparatus can through the same connecting port to connect with the digital apparatus with different interface to perform the data transmission.

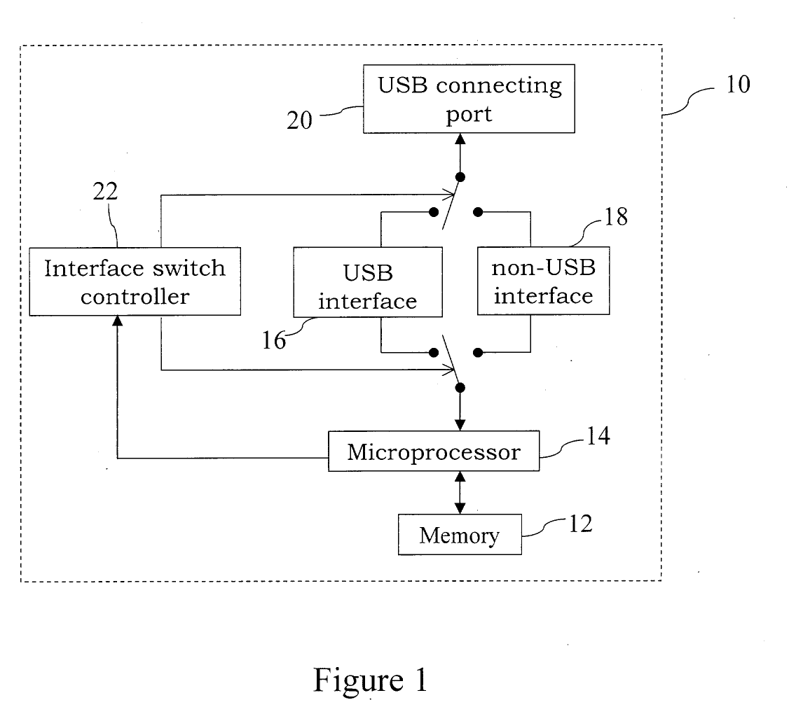

Referring to the FIG. 1, it is a schematic representation of the block diagram of the architecture in accordance with the present invention. A data storage apparatus 10 is including a memory 12 provided for the use of data storing. The memory 12 can be usually selected from the group of the flash memory, the electrically erasable programmable read-only memory (EEPROM), and the mask memory. A microprocessor 14 is coupled with the memory 12 for controlling the access of the data within the memory 12. The microprocessor 14 is coupled with two serial bus interface 16, 18, which are a USB interface 16 and a non-USB interface 18 respectively for deal with a communication protocol and a transmission of the connecting interface. Wherein there are also able more than two different non-USB interfaces 18. Those serial bus interfaces 16, 18 are coupled with a USB connecting port 20, which is provided for connecting to a connecting port (not shown in the figure) of a digital apparatus to form an interface connection relation thereof. There is an interface switch controller 22, which is connecting to the USB connecting port 20 and those serial bus interfaces 16, 18 there between and electrically connecting to those serial bus interfaces 16, 18 and the microprocessor 14 there between, used for detecting an interface property connected by the USB connecting port 20 and to converting to the corresponding serial bus interfaces 16, 18.

Wherein the USB connecting port 20 does not limit as the USB one, but also could be replaced by a USB compatible connecting port. In other words, the USB connecting port 20 is provided with not only the USB pins, but also arranged with a plurality of pins for simultaneously suitable for the non-USB connecting port. Those serial bus interfaces 16, 18 could also be built-in in the microprocessor, and the interface switch controller 22 is merely connecting to the position between the USB connecting port 20 and the microprocessor. On the other hand, the interface switch controller 22 could be also built in the microprocessor 14 for integrating the control circuit as one body.

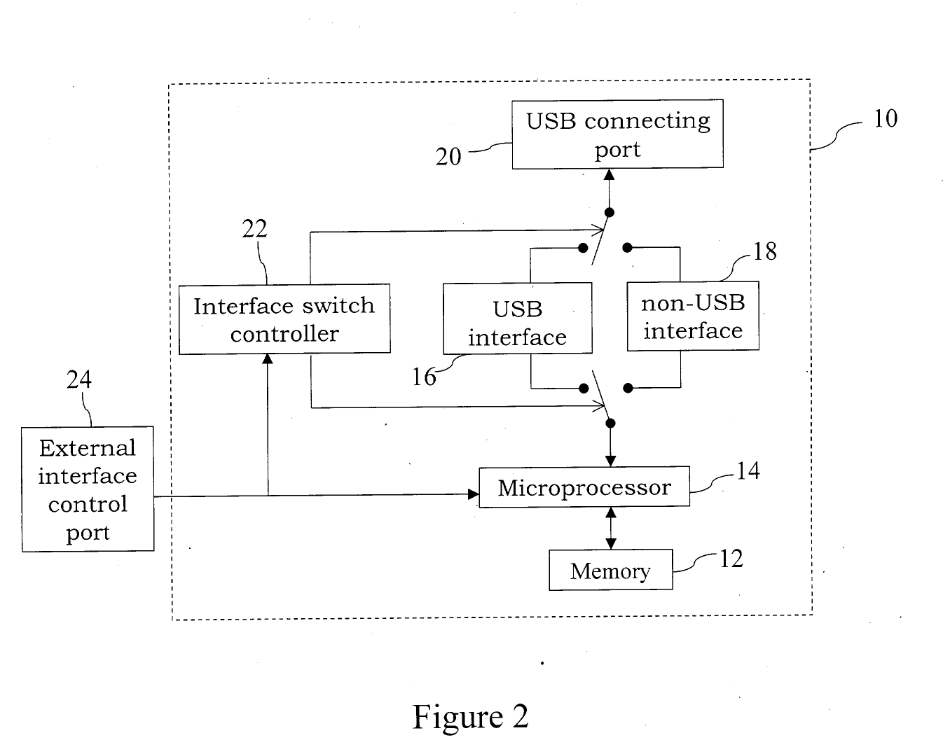

Referring to the FIG. 2, it is another preferred embodiment of the present invention. Such as shown in the figure, an external interface control port 24 is connecting to the microprocessor 14 and the interface switch controller 22 within the data storage apparatus 10 for identifying and controlling the digital apparatus connected with the USB connecting port 20 by simultaneously utilizing the interface switch controller 22 and the external interface control port 24, wherein the communication interface of the digital apparatus provided with the USB interface or not provided with the USB interface but other serial interfaces is used for converting to the suitable serial bus interface 16, 18.

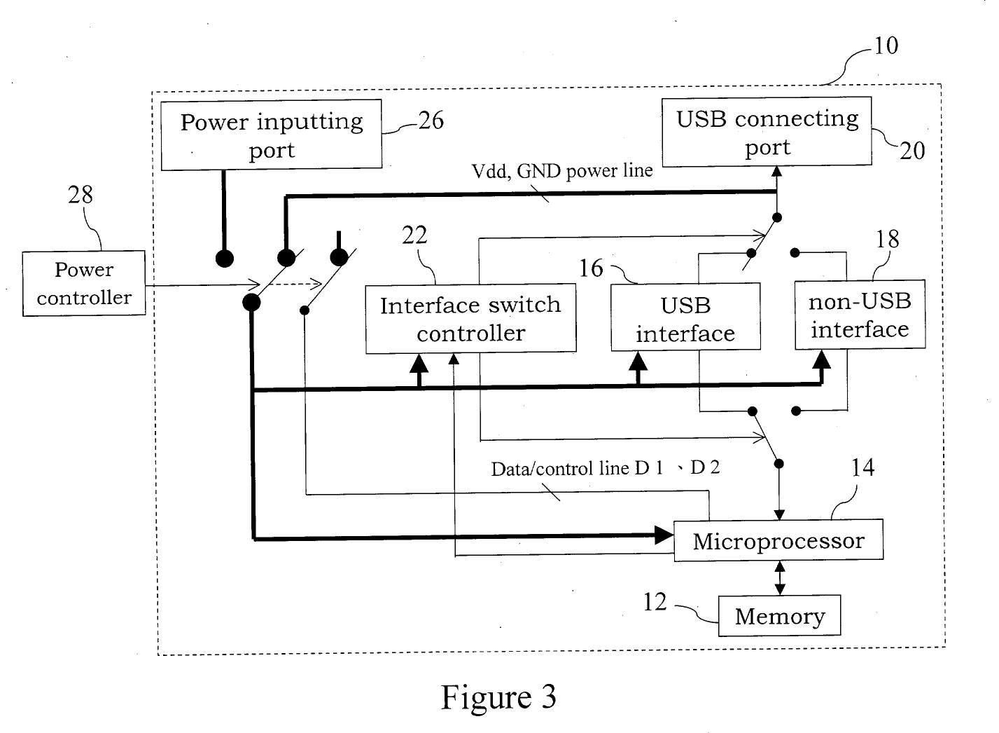

Following, in order to illustrate the action relation of the data storage apparatus 10 connecting to the digital apparatus and then to covert the corresponding connecting interface, referring to the FIG. 3, it is a schematic representation of one applied circuit in accordance with the present invention. Such as shown in the figure, the signal line of the USB connecting port 20 is including an electric power line V_{dd}, GND and a the data/control signal line Data+, Data− (not shown in the figure) electrically connecting to the microprocessor 14 so as to input the electric power from the digital apparatus connected by the USB connecting port 20 via the electric power line V_{dd}, GND and utilize the microprocessor 14 to perform the data operation via the data/control signal line Data+, Data−. There is further including an electric power inputting port 26 to externally arrange an electric power supply apparatus for inputting all required power for the action of each element within the data storage apparatus 10. Besides, there is also externally arranged an electric power controller 28 for selecting the power source for the action of each element within the data storage apparatus 10, wherein the power source is input via the digital apparatus connected by the USB connecting port or the electric power inputting port 26. Wherein, the electric power controller 28 could be also built-in in the microprocessor 14 and the electric power supply apparatus connected with the electric power inputting port 26 could be also built-in in the microprocessor 14 so as to integrate the related circuit within the data storage apparatus 10.

When the USB connecting port 20 and the connecting port of a digital apparatus are connecting with each other to form a signal connection relation, the interface switch controller 22 will detect the communication protocol of the digital apparatus if there is a USB interface. If there is a USB interface, the interface switch controller 22 will convert the connecting interface into the USB interface 16 so as to through the USB connecting port 20 utilizing the USB interface 16 to perform the data transmission and the data accessing.

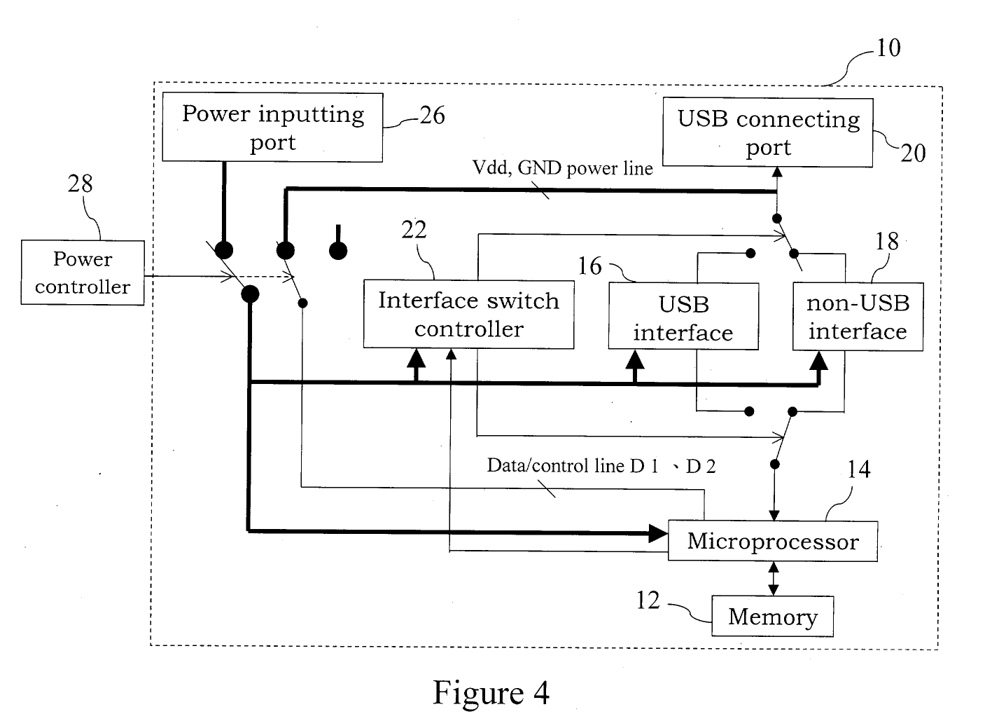

If the detection of the interface switch controller 22 is the digital apparatus does not have the USB interface but other serial interfaces, the interface switch controller 22 will convert the connecting interface into the non-USB interface 18 to through the USB connecting port 20 utilizing the non-USB interface 18 to perform the data transmission and the data accessing. Wherein, such as shown in the FIG. 4, while the USB interface 16 is converting into the non-USB interface 18, the electric power line V_{dd}, GND is simultaneously converting into another data signal line D1, D2 for using. At this time, the electric power of the data storage apparatus 10 could not input from the digital apparatus connected by the USB connecting port 20 via the power line V_{dd}, GND. The electric power controller 28 will detect the change and synchronously or preferentially convert the path of the electric power input into the input of the electric power inputting port 26.

Hence, the present invention can convert the electric power signal line of the USB connecting port 20 into the data/control signal line so as the data/control signal line increase another data/ control signal line D1, D2 from two original signal lines Data+, Data− into four data/control lines. The present invention can improve the prior problem that the signal lines of some serial ports are not enough to achieve the effect of increasing the amount of data and controll lines. Wherein, the USB connecting port 20 is the USB compatible connecting port mentioned above and the data/control signal lines can be increased more than four lines. Simultaneously, when the digital apparatus connected to the data storage apparatus 10 is the personal digital assistant (PDA), the digital camera, which is the apparatus with the short power-on time of the original battery, the present invention can also utilize a electric power supply apparatus externally arranged or the internal power supply apparatus within the data storage apparatus 10 to provide the required power so as to solve the prior problem, which is the disadvantage of the peripheral hard discs speedily power consuming of the digital apparatus.

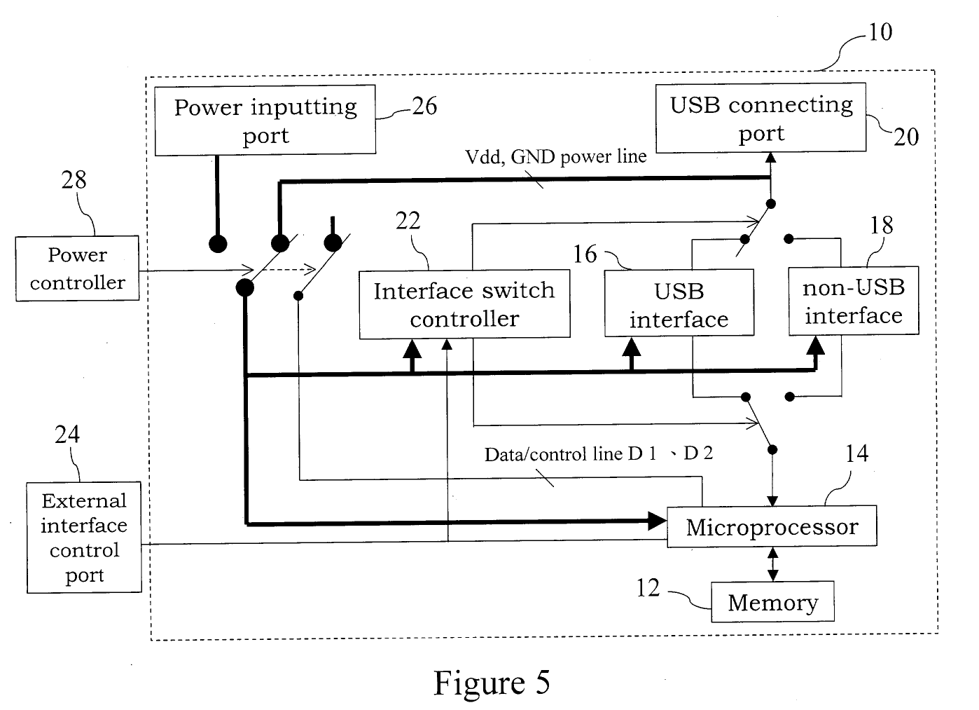

Referring to the FIG. 5, it is a schematic representation of another applied circuit of the data storage apparatus 10 in accordance with the present invention. The data storage apparatus 10 is connecting with the digital apparatus to convert the corresponding action relation of the connecting interface. The electric power controller 28 selecting the action relation of the power source is the same as the embodiment of the FIG. 2 and the FIG. 4 mentioned above, so there is no more redundant words herein.

Hence, the present invention provides a data storage apparatus with a multiple serials interface, which cannot only be suitable for the USB interface but also the non-USB interface. The present invention utilizes the same connecting port to connect the digital apparatus with different connection interface and provides the effect of the multi serial interface so as the data transmission becomes more convenient. Besides, the present invention is a portable data storage apparatus provided with a multiple serials interface, which simultaneously provides with the advantage of the simple structure design and the low cost and the user can flexibly select the serial interface corresponding to the requirement of the system architecture.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A data storage apparatus with a multiple serials interface, said data storage apparatus including:
at least a memory providing for data-storing;
a microprocessor used for controlling the access of a data stored in said memory;
at least two serial bus interfaces built-in in said microprocessor, wherein said two serial bus interfaces are including a universal serial bus (USB) interface and at least a non-USB interface for dealing with a communication protocol and a transmission of the connecting interface;
a connecting port, wherein said connecting port is USB compatible and is electrically connecting with said serial bus interfaces for providing the connection to a digital apparatus to form an interface connection relation thereof; and
an interface switch controller used for detecting an interface property connected by said connecting port and to converting to said corresponding serial bus interface.

2. The data storage apparatus with a multiple serials interface according to claim 1, further comprises an external interface control port for connecting with said microprocessor and said interface switch controller.

3. The data storage apparatus with a multiple serials interface according to claim 1, further comprising an electric power input port.

4. The data storage apparatus with a multiple serials interface according to claim 3, wherein said microprocessor is further built-in an electric power controller for selecting an action power source of each element in said data storage apparatus with said multiple serials interface, wherein said action power source is input by said digital apparatus or said electric power port.

5. The data storage apparatus with a multiple serials interface according to claim 3, further connecting an electric power controller for selecting an action power source of each element in said data storage apparatus with said multiple serials interface, wherein said action power source is input by said digital apparatus or said electric power port.

6. The data storage apparatus with a multiple serials interface according to claim 1, wherein a signal line of said connecting port is including a electric power line and at least a data signal line, and while said interface switch controller converting said USB interface into said non-USB interface, said electric power line is simultaneously converting for the use of another data signal line.

7. The data storage apparatus with a multiple serials interface according to claim 1, wherein said switch controller is connecting between said connecting port and said serial bus interfaces.

8. The data storage apparatus with a multiple serials interface according to claim 1, wherein said switch controller is built-in in the said microprocessor.

9. A data storage apparatus with a multiple serials interface, said data storage apparatus including:
at least a memory providing for data-storing;
a microprocessor used for controlling the access of a data stored in said memory;
at least two serial bus interfaces connecting to said microprocessor, wherein said two serial bus interfaces are including a universal serial bus (USB) interface and at least a non-USB interface for dealing with a communication protocol and a transmission of the connecting interface;
a connecting port, wherein said connecting port is USB compatible and is electrically connecting with said serial bus interfaces for providing the connection to a digital apparatus to form an interface connection relation thereof; and
an interface switch controller used for detecting an interface property connected by said connecting port and to converting to said corresponding serial bus interface.

10. The data storage apparatus with a multiple serials interface according to claim 9, wherein further comprises an external interface control port for connecting with said microprocessor and said interface switch controller.

11. The data storage apparatus with a multiple serials interface according to claim 9, further comprising an electric power input port.

12. The data storage apparatus with a multiple serials interface according to claim 11, wherein said microprocessor is further built-in an electric power controller for selecting an action power source of each element in said data storage apparatus with said multiple serials interface, wherein said action power source is input by said digital apparatus or said electric power port.

13. The data storage apparatus with a multiple serials interface according to claim 11, further connecting an electric power controller for selecting an action power source of each element in said data storage apparatus with said multiple serials interface, wherein said action power source is input by said digital apparatus or said electric power port.

14. The data storage apparatus with a multiple serials interface according to claim 11, wherein a signal line of said connecting port is including a electric power line and at least a data signal line, and while said interface switch controller converting said USB interface into said non-USB interface, said electric power line is simultaneously converting for the use of another data signal line.

15. The data storage apparatus with a multiple serials interface according to claim 11, wherein said switch controller is connecting between said connecting port and said serial bus interfaces, and electrically connecting between said serial bus interfaces and said microprocessor.

16. The data storage apparatus with a multiple serials interface according to claim 11, wherein said switch controller is built-in in the said microprocessor.
